(19) United States
(12) Patent Application Publication
(10) Pub. No.: US 2007/0133380 A1
(43) Pub. Date: Jun. 14, 2007

(54) Optical recording disc adapted to storing data using an ultra-violet laser source

(75) Inventors: Erwin Rinaldo Meinders, Eindhoven (NL); Andrei Mijiritskii, Eindhoven (NL); Hubert Cecile Francois Martens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,554

(22) PCT Filed: Mar. 3, 2005
(86) PCT No.: PCT/IB05/50786

§ 371 Date: Sep. 5, 2006

(30) Foreign Application Priority Data
Mar. 9, 2004 (EP) 04100939.0

(51) Int. Cl. G11B 7/24

(52) U.S. Cl. 369/275.4

(57) ABSTRACT

Optical record carrier (20) adapted to storing data using a recording/reading device. The recording/reading device comprises an ultra-violet laser source emitting electromagnetic radiation (29) having a wavelength X in the range of 230 nm to 270 nm. The recording/reading device further comprises an objective lens (21) for focussing the electromagnetic radiation (29) on the optical recording carrier NA is the numerical aperture of the objective lens. The optical record carrier comprises a spiral track (22), which has a track pitch TP between 0.55* λ/NA and 0.75* λ/NA.

The present invention relates to an optical record carrier for storing data using a recording/reading device. Said recording/reading device comprises an ultra-violet laser having a wavelength λ in the range of 230 nm to 270 nm. The recording device comprises an objective lens for focussing the laser beam on the optical recording disc. The objective lens has a predetermined numerical aperture NA.

Optical data storage systems have seen an evolutionary increase in the data capacity. Optical storage systems and in particular optical discs are read by a monochromatic laser beam, which is focussed via an objective lens on the disc. The data capacity of the optical disc is limited by the size of the focal point of the monochromatic laser beam. The optical spot size is proportional to the wavelength of the used laser light (λ) and the numerical aperture of the objective lens (NA):

$$D ∝ \frac{λ}{NA}$$

The total data capacity of an optical disc is determined by the size of the optical spot of the readout and/or recording system.

By increasing the numerical aperture (NA) of the objective lens and reducing the laser wavelength (λ) the total data capacity was increased from 650 Mbyte (CD, NA=0.45, λ=780 nm) to 4.7 Gbyte (DVD, NA=0.60, λ=650 nm), and even 25 Gbyte (BD, former DVR, NA=0.85, λ=405 nm). The BD (Blu-ray Disc) data density was derived from the DVD capacity via optical scaling.

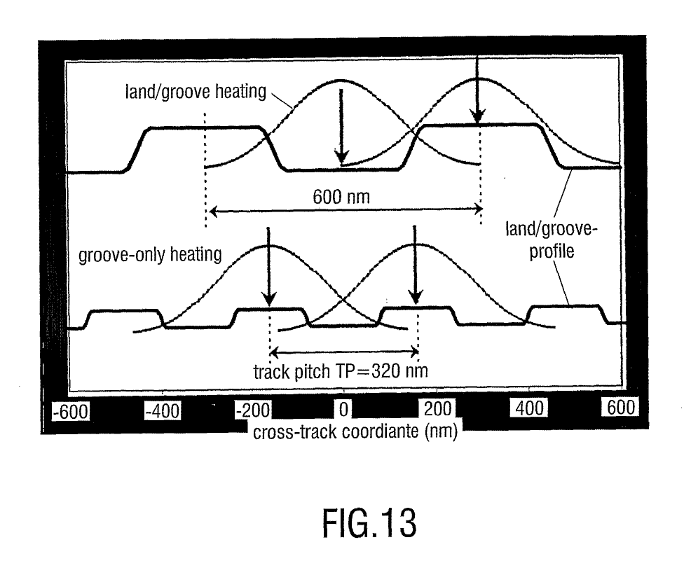

The focused laser beam must be driven by a control mechanism, so that the track is accurately followed during readout or recording of data. The track is the area on the disc, in which information is to be recorded. Commonly the track has a spiral shape. The focal point of the laser beam has to follow the track in order to read or record information on the disc. To this end, a spiral groove structure is provided on an optical disc. For groove-only recording, data are written in the groove plateaux or on the adjacent land plateaux. In this text, we denote the plateau closest to the incident laser beam the on-groove plateau. The plateau farthest away from the incident laser beam is called the in-groove plateau. Data may also be written on both the in-groove and on-groove plateaux. This recording scheme is called in-groove/on-groove recording. FIG. 13 schematically represents both in-groove/on-groove recording. The track is the location where the data are written, in the on-groove or in-groove plateaux (groove-only recording), or both on the in-groove and on-groove plateau (in-groove/on-groove recording). The distance between two tracks is called the track-pitch (TP).

The tracking error is the difference between the desired position and the actual position of the focal point of the laser beam. The desired position of the focal point is at the centre of the track. The optical parameter used for generating the tracking error signal is commonly known as push-pull signal. The recording/reading device has auxiliary detectors for generating a push-pull signal based on the groove structure in order to detect a spatial deviation of the focal point with respect to the track. The push-pull signal is used to control actuators that position the recording head and consequently the focal point on the track during rotation of the disc

The groove structure is characterized by the groove depth d, the flank angle θ, the groove width L1 and the groove duty cycle. The definitions are given in FIG. 2. In case of an in-groove alignment shown in FIG. 2, the pitch between two adjacent grooves corresponds to the track pitch. The groove depth d is the depth of the groove. The groove duty cycle is defined by the width of the groove L1 divided by the track pitch TP. The flank angle θ determines the slope between a groove and an adjacent plateau. In the current definition, on-groove refers to the part of the substrate that is first seen by the incident laser beam (the plateau), in-groove refers to the part of the substrate that is farther away from the incident laser beam (the groove).

In addition, the groove shape has also a significant impact on the local light absorption. It is, for example, known from the land/groove recording scheme in the initial phase of the Blu-ray Disc system (the DVR system) that the land and groove plateaus exhibited different recording phenomena. In the land/groove definition scheme distinct differences between land and groove heating were observed with respect to write power and thermal cross-write (the phenomenon that marks in adjacent tracks are partly erased by writing marks in the central track). Groove (in-groove) heating leads to higher write powers and more thermal cross-write. A proper selection of the groove shape with optimum performance both with respect to tracking and optical absorption is therefore of utmost importance for high-quality optical data recording.

It is object of the present invention to provide an optical record carrier for storing data, which has a scaled data capacity for deep-UV recording and is optimised with respect to tracking and optical absorption.

The object is solved by an optical record carrier for storing data characterized by a spiral track having a track pitch TP between 0.55*λ/NA and 0.75*λ/NA for both groove-only and in-groove/on-groove recording. λ is the wavelength of the ultra-violet laser used for reading/recording data, and ranges between 230 nm to 270 nm. NA is the numerical aperture of the objective lens used for focussing the laser beam onto the optical recording disc. A typical numerical aperture for high-end objective lenses, such as currently used for the Blu-ray Disc system, is NA=0.85. In that case, the effective spot radius R0, i.e. the radius at which the intensity of the laser spot has decreased to 1/e of its maximum intensity, of a system with λ=266 nm is R0=99 nm. This value of R0 is compared to that of the other three known systems (CD, DVD and BD) in Table 1. Also, the related spot area and anticipated data capacities are given. If the effective spot area (πR0²) is considered, it can be seen that a data capacity of 60-65 Gbyte is anticipated for the UV system. The gained data capacity is lower for a numerical aperture NA=0.65 than for a numerical aperture NA=0.85.

TABLE 1
Spot size and scaled data capacities of four generations optical
storage systems.

| | λ | | R0 | Spot area | Data capacity |
|---|---|---|---|---|---|
| System | (nm) | NA | (nm) | (m\hat{ }2) | (GB) |
| CD | 780 | 0.45 | 495 | 7.7E−13 | 0.65 |
| DVD | 670 | 0.65 | 327 | 3.4E−13 | 4.7 |
| BD | 405 | 0.85 | 151 | 7.2E−14 | 25 |
| UV | 266 | 0.85 | 99 | 3.1E−14 | 60-65 |
| UV | 266 | 0.65 | 130 | 5.3E−14 | 30-35 |

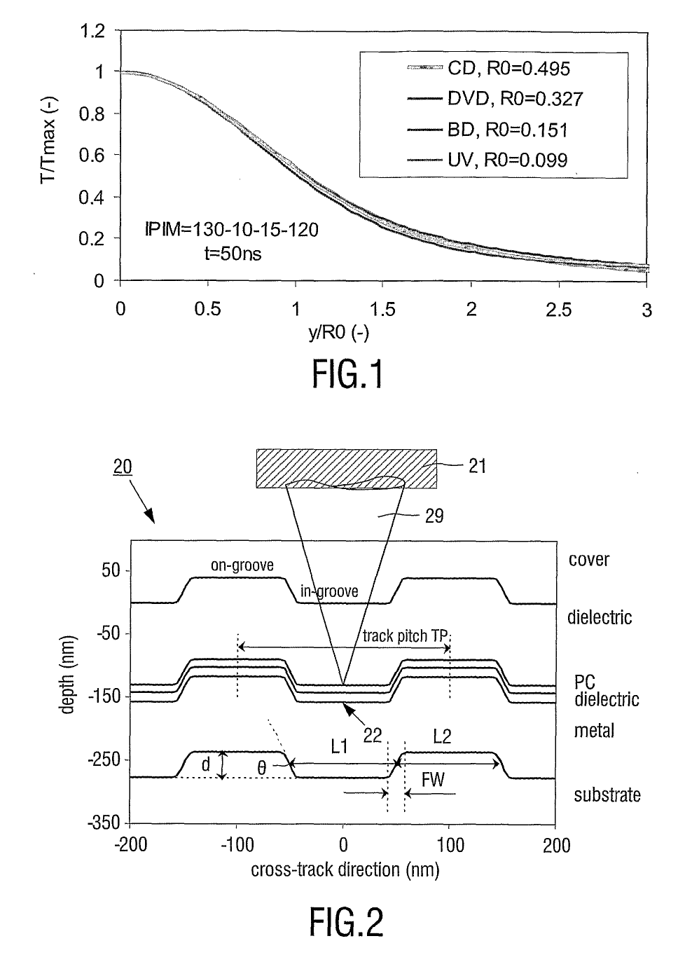

In conclusion, the effective spot radius R0 is about 100 nm for λ=266 nm and NA=0.85. If a too small track pitch is pursued, the optical spot will largely overlap with the adjacent tracks and with written data which may lead to data deterioration, optical cross talk during readout of data, and severe reduction of the push-pull tracking signal. On the other hand, if a too broad track pitch is pursued, the targeted data capacity will never be obtained. The optimum data track pitch with respect to minimum thermal cross-write, acceptable optical cross talk, acceptable push-pull signals, and maximum achievable data capacity is achieved by the present invention. Numerical simulations of the cross-track (lateral) temperature profiles for a CD, DVD, BD and UV system are given in FIG. 1.

FIG. 1 shows the cross-track (lateral) temperature profiles for CD, DVD, BD and UV conditions as a result of laser pulse heating (50 ns write pulses). The profiles are normalized with the maximum temperature at the centre of the track and plotted as a function of the cross-track (lateral) coordinate scaled with the effective spot size (R0).

It is seen that all temperature profiles scale to the same generic curve. From the figure, we see that the temperature in the centre of the adjacent track has dropped to 0.2 times the maximum temperature Tmax at a radial position y=2*Ro.

In phase-change based rewritable optical discs, the thermal cross-write is in particular a (partial) re-crystallisation of marks in the adjacent tracks due to writing in the central track. Laser-induced re-crystallisation occurs at temperatures above the crystallization temperature (200°-300° C.). The maximum temperature (Tmax) in the track is about 800° C.-1000° C. to enable melting of a sufficiently broad mark. Depending on the detailed properties of the recording material, a temperature of 0.2 Tmax or less in an adjacent track is a reasonable criterion to avoid thermal cross-write. In this case, the temperature stays below 200° C. at the adjacent track. If we take TP=2*R0 as the minimum value of the track pitch, thermal cross-write may be avoided. If a Gaussian profile is fitted on the spot intensity distribution, the following expression for R0 is obtained:
R0=0.52* 1.22*λ/(2*NA)

In order to avoid the thermal cross-write as much as possible, TP=2*R0 is preferred. Thus
TP=2*R0
TP=2*0.52* 1.22*λ/(2*NA)
TP=0.63*λ/NA

A range around the value 0.63 is claimed, namely
0.55*λ/NA<TP<0.75*λ/NA

The lower limit 0.55 is dictated by thermal cross-write in practical materials. The upper limit 0.75 relates to the data capacity. Therefore, an optical disc for UV-lasers is provided, which has an optimised track pitch

Preferably the optical recording disc is characterized by a groove depth d, wherein said groove depth is between

$$\frac{1}{12} * \frac{λ}{n 0} and \frac{1}{4} * \frac{λ}{n 0} ,$$

n0 being a refractive index of a cover layer of the optical recording disc. The groove depth determines the amplitude of the push-pull signal used for tracking. The push pull signal must be strong enough in order to determine, whether the laser spot is on track or not.

The groove depth is chosen such, that partial destructive interference occurs between a light beam of wavelength λ reflected in groove and light beam of wavelength λ on groove. If the optical retardation between the light beam reflected from the land and the light beam reflected from the groove is λ(n0*2), i.e. 2*d*n0=λ/2, the two beams cancel out each other completely and the total reflected light intensity from the optical disc is minimal. n0 is the refractive index of the medium in between the recording stack and the objective lens. In case a cover is used, the index of refraction n0 is that of the cover material, for air-incident recording n0=1. d is the groove depth and 2*d*n0 is the optical retardation between beams reflected from in-groove and on-groove. The optical path difference between on-groove and in-groove is defined as d*n0 or half the optical retardation.

Thus, the groove depth should be smaller than d=λ/(4*n0), in order to avoid complete destructive interference which results in very low reflected light intensity and hence very low signal amplitude. For groove depths greater than this value the polarity of the push-pull tracking signal reverses. Therefore, in practical discs, a path difference around λ/8 is used. The minimum path difference of λ/12 is to guarantee a sufficiently large tracking signal. This is not a hard bound since the push-pull amplitude depends not only on groove depth but as well on track pitch: for larger track pitch somewhat shallower grooves can be accepted.

The invention covers both groove-only recording and in-groove/on-groove recording. Groove-only recording is the recording scheme in which only the in-groove or on-groove plateaux are used for recording. In in-groove/on-groove recording, both plateaux are used for recording. The two recording schemes are illustrated in FIG. 13 for Blu-ray Disc conditions. The arrows indicate incident laser beams. A graph for in-groove/on-groove recording (upper graph) and a graph for groove-only recording (lower graph) are shown in FIG. 13. The lower graph represents a recording scheme, in which on-groove plateaux are used for recording. The track pitch TP of the lower graph is equal to 320 nm and corresponds to the distance between the centres of adjacent plateaus. The track pitch TP of the upper graph is equal to 300 nm and corresponds to the distance between the centre of a plateau and the centre of an adjacent groove. The distance between the centres of two adjacent plateaus in the upper graph is equal to 600 nm.

Preferably the optical disc has a groove duty cycle DC between 30% and 70% If the duty approaches 0% or 100% the push-pull signal vanishes.

A preferred embodiment of the present invention will now be described with reference to the accompanied drawings.

FIG. 1 shows a diagram of cross-track (lateral) temperature profiles for CD, DVD, BD and UV conditions as a result of laser pulse heating (50 ns write pulses). The profiles are normalized with the maximum temperature at the centre of the track and plotted as a function of cross-track (lateral) coordinate scaled with the effective optical spot size (R0).

FIG. 2 is a schematic representation of the preferred embodiment of the present invention.

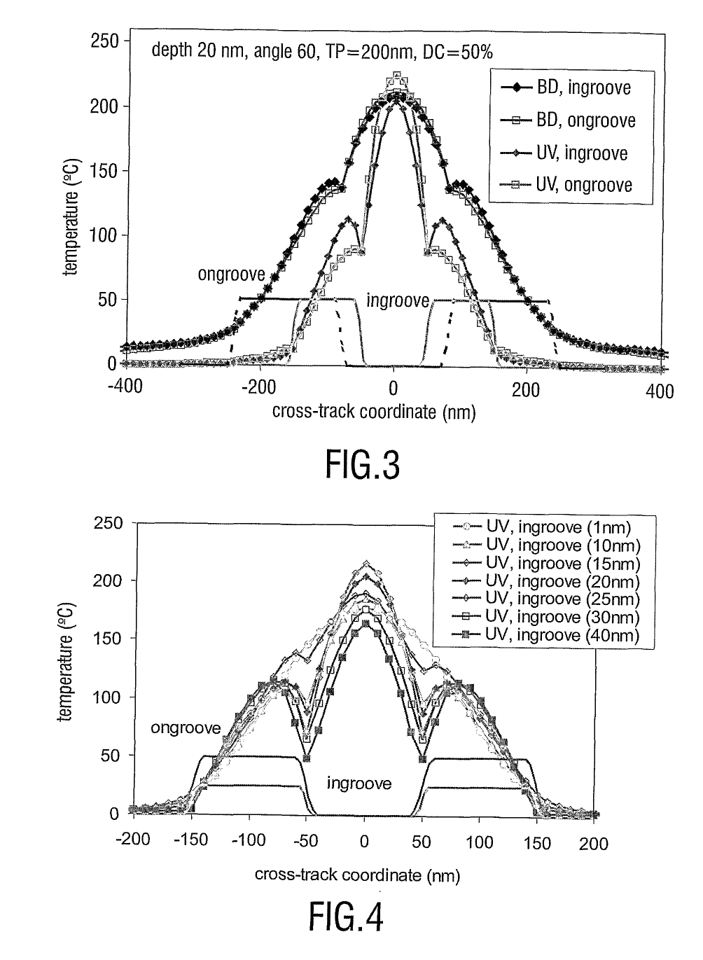

FIG. 3 shows cross-track temperature profiles in grooved BD and UV media. Shown are the in-groove and on-groove temperature profiles.

FIG. 4 shows cross-track temperature profiles for in-groove heating for several groove depths (UV recording conditions).

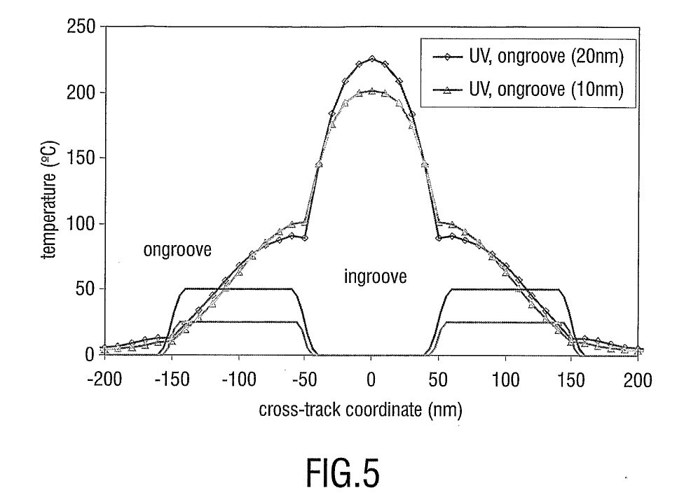

FIG. 5 shows cross-track temperature profiles for on-groove heating for two groove depths (UV recording conditions).

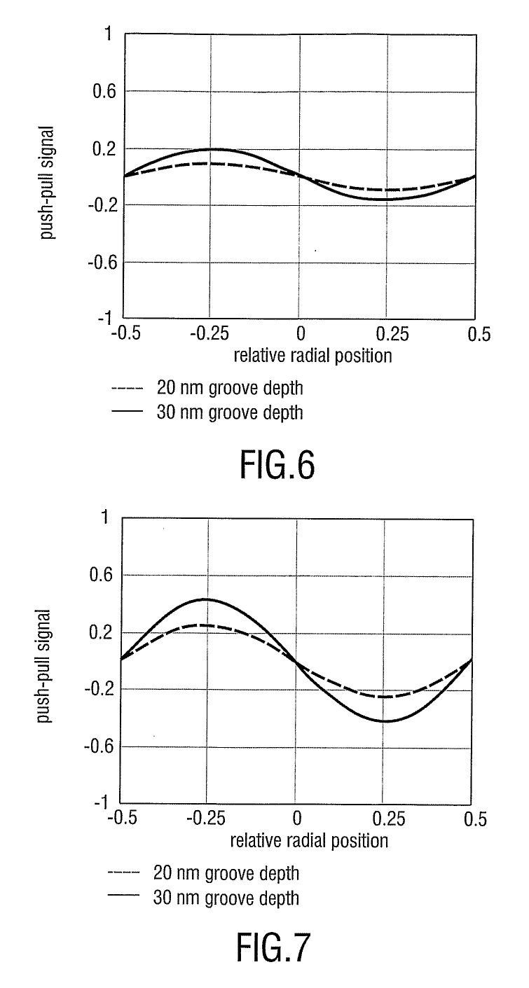

FIG. 6 shows push-pull signal as a function of a radial position normalised to the track pitch. Recording is carried out through the cover layer. The track pitch TP is equal to 175 nm and the groove duty cycle is equal to 50%.

FIG. 7 shows a push-pull signal as a function of a radial position normalised to the track pitch. Recording is carried out through the cover layer, the track pitch TP is equal to 200 nm and the groove duty cycle is equal to 50%.

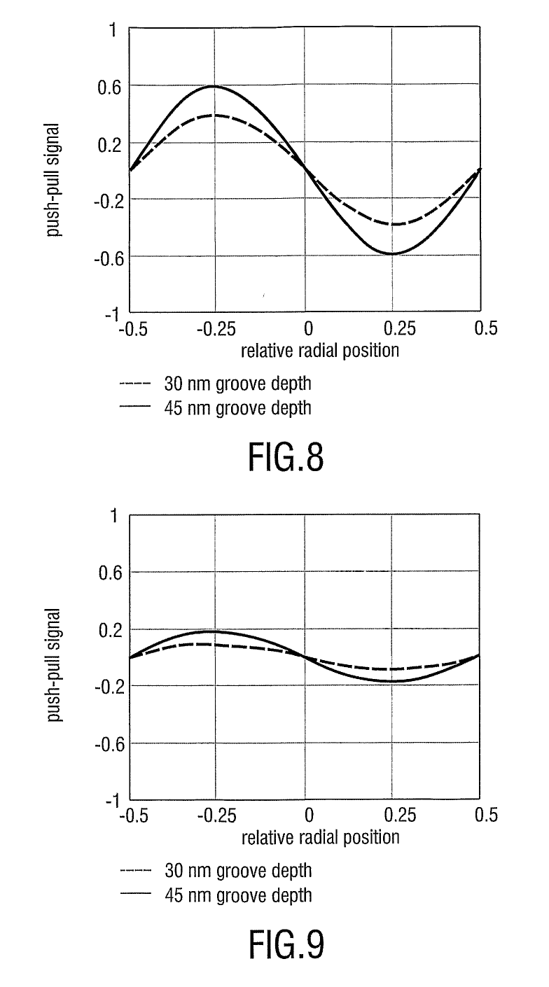

FIG. 8 shows a push-pull signal as a function of a radial position normalised to the track pitch. Recording is carried out through the cover layer, the track pitch TP is equal to 225 nm and the groove duty cycle is equal to 50%.

FIG. 9 shows a push-pull signal as a function of the radial position normalised to the track pitch. Air-incident recording is performed. The track pitch TP is equal to 175 nm and the groove duty cycle is equal to 50%.

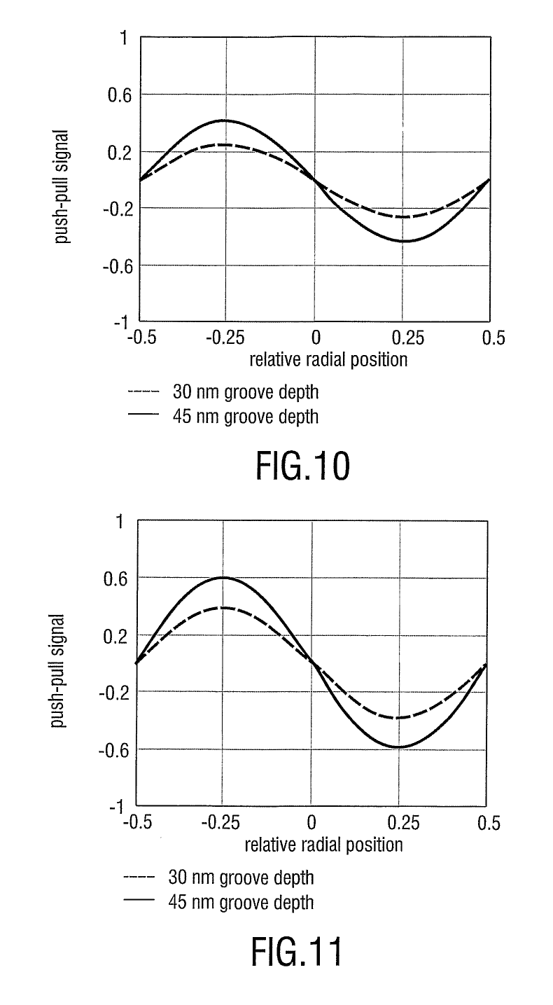

FIG. 10 shows a push-pull signal as a function of the radial position normalised to the track pitch. Air-incident recording is performed, the track pitch TP is equal to 200 nm and the groove duty cycle is equal to 50%.

FIG. 11 shows a Push-pull signal as a function of the radial position normalised to the track pitch. Air-incident recording is performed, the track pitch TP is equal to 200 nm and the groove duty cycle is equal to 50%.

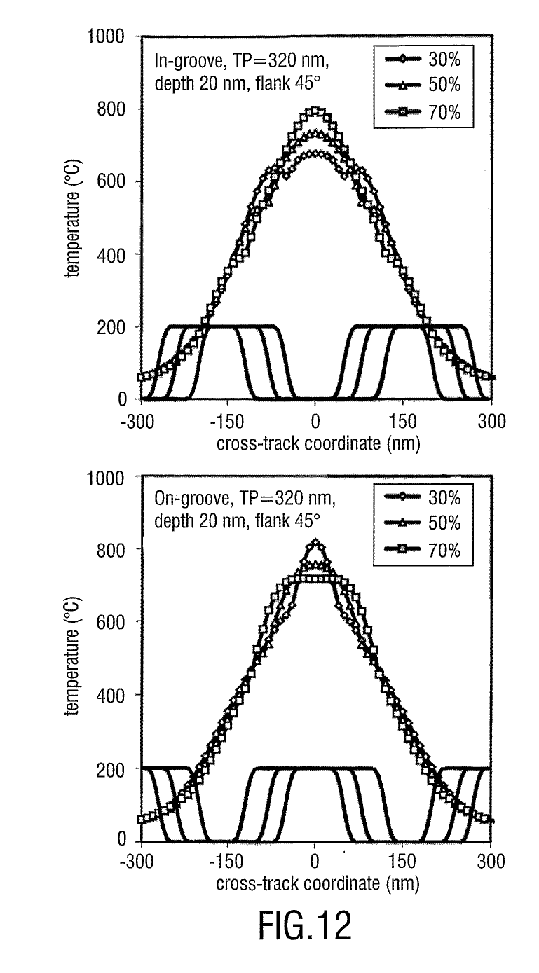

FIG. 12 shows two graphs representing cross-track temperature profiles for in-groove and on-groove heating in optical discs having groove duty cycles of 30%, 50% and 70%.

FIG. 13 is a schematic illustration of land/groove and groove-only heating and recording.

FIG. 2 is a schematic representation of an embodiment of the present invention. It shows the proposed conformal groove shape. The MIPI stack (M refers to metal, I refers to the dielectric layers and P is the phase-change layer) is deposited on a pre-grooved substrate. The optical record carrier shown in FIG. 2 consists of the following layers: a cover layer, a top dielectric layer, the phase change layer PC, a bottom dielectric layer, a metal layer and finally the substrate layer.

The cone 29 indicates the direction of the focussed incident electromagnetic radiation beam. In-groove refers to the mastered groove in the substrate. A groove-only recording scheme is being considered. An in-groove/on-groove-recording scheme is a further realisation of the present invention, which is not covered by the present embodiment. In case of the in-groove alignment shown in FIG. 2, the pitch between two adjacent grooves corresponds to the track pitch TP. Other groove dimensions are the flank width FW, the in-groove width L1, the on-groove width L2, the flank angle θ and the groove depth d. On-groove are the land plateaus. As can be seen in FIG. 2, the track pitch TP of the recording medium is equal to 200 nm; the groove depth is equal to 20 nm; the groove duty cycle is equal to 50%. Both the on-groove and in-groove width L1 and L2 have a width of 100 nm. The flank angle θ is equal to 60°. The flank width FW is equal to 11.5 nm.

The following table 2 represents the properties of the optical disc of the present embodiment shown in FIG. 2. N is the index of refraction of the respective layer and K is the absorption coefficient of the different layers at the wavelength of 266 nm.

TABLE 2
Layout of stack with layer thickness and optical properties
(at wavelength λ = 266 nm).

| Disc layers | N | K | Thickness (nm) |
|---|---|---|---|
| Cover | 1.768 | 0 | >55 |
| Top Dielectric | 2.655 | 0 | 130 |
| PC-layer SbTe | 1.0 | 1.94 | 12 |
| Bottom Dielectric | 2.655 | 0 | 15 |
| Metal Ag | 0.31 | 3.25 | 120 |
| Substrate | 1.768 | 0 | >90 |

The optical recording disc shown in FIG. 2 is optimised for a laser having a wavelength equal to 266 nm and an objective lens having a numerical aperture NA=0.85. The track pitch equal to 200 nm is given by TP=0.64*λ/NA. This is well within the range covered by appended claim 1. The groove depth of 20 nm corresponds to

$$\frac{1}{7.5} * \frac{λ}{n 0} ,$$

which is well within the range covered by appended claim 2. The 50% groove duty cycle is subsumable under appended claim 3.

Cross-track temperature profiles are given in FIG. 3 for BD and UV optical record carriers with a groove depth of 20 nm. The other parameters for the BD stack were TP=320 nm, FW=11.5 nm, L1=L2=160 nm (DC=50%), the parameters for the UV groove shape were TP=200 nm, FW=11.5 nm, L1=L2=100 nm (DC=50%). The UV medium corresponds to the embodiment of FIG. 2. Shown are the temperature profiles for in-groove and on-groove heating. The on-groove profiles are ½ TP shifted to facilitate the comparison between in-groove and on-groove heating. For a 20 nm deep groove, it is seen that differences between in-groove and on-groove heating are relatively small for BD recording conditions (NA=0.85, λ=405 nm) while differences are significant for UV recording (NA=0.85, λ=266 nm). For both recording systems, on-groove heating leads to lower side lobes and broader central peak temperatures.

The narrower two curves shown in the graph of FIG. 3 represent the UV-temperature profiles for in-groove and-on groove tracks. The temperature distribution of the UV-curves is better than the distribution of the BD-curves, since the UV-curves have smaller side lobes and a high peak. Therefore, thermal cross-write is more easily avoided.

Thermal cross-write is the phenomenon that marks present in adjacent tracks are partly erased or overwritten during writing in the central track. In-groove heating will cause higher temperatures in the adjacent tracks and therefore, in-groove recording is more sensitive to thermal cross-write. In case of the UV system, the marks in the adjacent tracks are located at y=TP=200 nm. Therefore, the side lobes extend only to y-100 nm and will most probably hardly cause partial re-crystallization of the adjacent marks. If the melt-edge is taken as criterion for mark formation, on-groove recording results in a broader mark. Obviously, on-groove recording requires less write power than in-groove recording.

The cross-track temperature profiles for in-groove heating are indicated in FIG. 4 for various groove depths. From the profiles, it is clear that a groove depth of 25 nm leads to a maximum temperature in the centre of the track. Cross-track temperature profiles for on-groove heating are shown in FIG. 5. The temperature profiles are broader at the central track and have also less pronounced side lobes.

Both in-groove and on-groove heating can be considered for UV recording. In case of groove-only recording, the marks are partly written at the adjacent flanks and plateaus. If marks are required with a width that exceeds the central plateau, in-groove recording is beneficial. One can advantageously use the relatively high side lobes and only moderate power levels are required for writing the marks. If narrow marks are pursued, for example to further reduce the data track pitch, on-groove recording is recommended. From a thermal point of view, the preferable groove depth is about 20-25 nm. Furthermore, the effect of duty cycle is important.

The effect of duty cycle is explained in FIG. 12 for Blue-ray Disc conditions. The upper graph in FIG. 13 shows a temperature distribution for in-groove recording. The lower graph in FIG. 13 shows a temperature distribution for on-groove recording. The track pitch TP, groove depth d and flank angle are identical for both graphs. The temperature profiles for different duty cycles DC, namely 30%, 50% and 705 are shown in both graphs. The side lobes in the temperature distribution become larger for in-groove recording compared to on-groove recording. A large duty cycle leads to broad temperature profiles. Confined temperature profiles result for in case of small duty cycles.

Push-pull tracking signals are shown for different optical disc structures in FIGS. 6 to 11. The push pull signals in FIG. 6 to 11 are calculation results. A tracking signal for λ=266 nm and NA=0.85 was assumed for the case of recording through a cover layer (refractive index n0=1.5) and for the case of air-incident recording (refractive index n0=1.0) for three different track pitches (TP).

FIG. 6 shows push-pull signal as a function of a radial position normalised to the track pitch. Recording is carried out through the cover layer. The track pitch TP is equal to 175 nm and the groove duty cycle is equal to 50%. In FIG. 7 recording is carried out through the cover layer, the track pitch TP is equal to 200 nm and the groove duty cycle is equal to 50%. In FIG. 8 recording is carried out through the cover layer, the track pitch TP is equal to 225 nm and the groove duty cycle is equal to 50%. In FIG. 9 air-incident recording is performed. The track pitch TP is equal to 175 nm and the groove duty cycle is equal to 50%. In FIG. 10 air-incident recording is performed, the track pitch TP is equal to 200 nm and the groove duty cycle is equal to 50%. In FIG. 11 air-incident recording is performed, the track pitch TP is equal to 200 nm and the groove duty cycle is equal to 50%.

A further requirement that must be considered in the choice for groove geometry is the push-pull signal that is required for tracking. While a small track pitch is beneficial from the data-capacity point of view, it deteriorates the push-pull signal thereby compromising the tracking reliability. In practice, a normalised push-pull signal of 0.2 provides a good compromise between tracking reliability and radial data density.

The curve for a 20 nm groove depth in the graph of FIG. 7 is the curve for the optical disc of the preferred embodiment shown in FIG. 2. The nornalised push-pull signal exceeds 0.2 for the above-mentioned curve. Therefore, the optical disc of the preferred embodiment provides for a satisfactory push-pull signal.

1. Optical record carrier (20) adapted to storing data using a recording/reading device, said recording/reading device comprising an ultra-violet laser source emitting electromagnetic radiation (29) having a wavelength λ in the range of 230 nm to 270 nm and an objective lens (21) having a numerical aperture NA for focussing the electromagnetic radiation on the optical recording carrier, characterized by a spiral track (22) having a track pitch TP between 0.55*λ/NA and 0.75*λ/NA.

2. Optical record carrier according to claim 1, characterized by a groove depth d, wherein said groove depth is between
$$\frac{1}{12} * \frac{λ}{n 0} and \frac{1}{4} * \frac{λ}{n 0} ,$$
n0 being a refractive index of a cover layer of the optical record carrier or n0 being equal to 1 in case of an optical record carrier without cover layer.

3. Optical record carrier according to claim 1, characterized by a groove duty cycle between 30% and 70%.
